(19) United States
(12) Patent Application Publication
(10) Pub. No.: US 2024/0101211 A1
(43) Pub. Date: Mar. 28, 2024

(54) ELECTRICAL DEVICE FOR HUMAN-POWERED VEHICLE

(71) Applicant: SHIMANO INC., Sakai City (JP)

(72) Inventors: Yasuyuki KOMADA, Sakai City (JP); Kodai HIROTA, Sakai City (JP); Hiroshi MATSUMOTO, Sakai City (JP)

(73) Assignee: SHIMANO INC., Sakai City (JP)

(21) Appl. No.: 18/464,272

(22) Filed: Sep. 11, 2023

(30) Foreign Application Priority Data
Sep. 28, 2022 (DE) 10 2022 124 930.1

(51) Int. Cl. B62J 9/40; B62J 45/00

(52) U.S. Cl. CPC B62J 9/40; B62J 45/00

(57) ABSTRACT

An electrical device for a human-powered vehicle comprises a main body, an item storage, and an actuator. The main body is configured to be coupled to a vehicle body of the human-powered vehicle. The item storage is at least partially provided to the main body so as to store an item. The item is free from function of the electrical device or non-operational with respect to the electrical device in a state where the item is at least partially arranged in the item storage. The actuator is coupled to the main body.

### CROSS-REFERENCE TO RELATED APPLICATIONS

The present application claims priority under 35 U.S.C. § 119 to German Patent Application No. 10 2022 124 930.1, filed Sep. 28, 2022. The contents of German Patent Application No. 10 2022 124 930.1 are incorporated herein by reference in their entirety.

### BACKGROUND

### Technical Field

The present invention relates to an electrical device for a human-powered vehicle.

### Background Information

A human-powered vehicle includes an electrical device. The human-powered vehicle and/or a user of the human-powered vehicle uses items such as a spare part, a tool, an accessory for the human-powered vehicle, and personal belongings of a user other than the spare part, the tool, the accessory, and the human-powered vehicle. It is preferable that the electrical device stores such items.

### SUMMARY

In accordance with a first aspect of the present invention, an electrical device for a human-powered vehicle comprises a main body, an item storage, and an actuator. The main body is configured to be coupled to a vehicle body of the human-powered vehicle. The item storage is at least partially provided to the main body so as to store an item. The item is free from function of the electrical device or non-operational with respect to the electrical device in a state where the item is at least partially arranged in the item storage. The actuator is coupled to the main body.

With the electrical device according to the first aspect, it is possible to use the item stored in the item storage provided to the main body. This can improve convenience of the human-powered vehicle.

In accordance with a second aspect of the present invention, the electrical device according to the first aspect is configured so that the item storage includes a storage space in which the item is to be at least partially provided.

With the electrical device according to the second aspect, the storage space enables the item to reliably be stored in the item storage.

In accordance with a third aspect of the present invention, the electrical device according to the first or second aspect is configured so that the item storage includes an item holder configured to hold the item.

With the electrical device according to the third aspect, it is possible to reliably hold the item using the item holder.

In accordance with a fourth aspect of the present invention, the electrical device according to the third aspect is configured so that the item holder is at least partially provided in the storage space.

With the electrical device according to the fourth aspect, it is possible to reliably hold the item in the storage space.

In accordance with a fifth aspect of the present invention, the electrical device according to the third or fourth aspect is configured so that the storage space is at least partially provided inside the main body.

With the electrical device according to the fifth aspect, it is possible to protect the item against foreign matter.

In accordance with a sixth aspect of the present invention, the electrical device according to any one of the first to fifth aspects is configured so that the main body includes a base part and an attachment body configured to be detachably and reattachably attached to the base part. The item storage is at least partially provided to the attachment body.

With the electrical device according to the sixth aspect, it is possible to access the item by detaching the attachment body from the base part.

In accordance with a seventh aspect of the present invention, the electrical device according to the sixth aspect is configured so that the base part and the attachment body define a storage space in which the item is to be at least partially provided.

With the electrical device according to the seventh aspect, the base part and the attachment body enable the item to reliably be stored in the item storage.

In accordance with an eighth aspect of the present invention, the electrical device according to the sixth or seventh aspect is configured so that the base part includes a first engagement part. The attachment body includes a second engagement part configured to be detachably and reattachably engaged with the first engagement part.

With the electrical device according to the first aspect, the first engagement part and the second engagement part enable the attachment body to be detachably and reattachably coupled to the base part with a comparative simple structure.

In accordance with a ninth aspect of the present invention, the electrical device according to any one of the first to eighth aspects further comprises a movable member movably coupled to the main body.

With the electrical device according to the ninth aspect, it is possible to move another member using the movable member.

In accordance with a tenth aspect of the present invention, the electrical device according to the ninth aspect is configured so that the actuator is coupled to the movable member to operate an operated device in response to a movement of the movable member.

With the electrical device according to the tenth aspect, the actuator enables the user to operate the operated device by moving the movable member relative to the base body.

In accordance with an eleventh aspect of the present invention, the electrical device according to the ninth or tenth aspect is configured so that the actuator is coupled to the movable member to move the movable member relative to the main body.

With the electrical device according to the eleventh aspect, it is possible to move the movable member relative to the base body using the actuator.

In accordance with a twelfth aspect of the present invention, the electrical device according to any one of the first to eleventh aspects is configured so that the main body includes a first end part and a second end part. The first end part is configured to be coupled to a vehicle body of the human-powered vehicle. The main body extends between the first end part and the second end part in a longitudinal direction.

With the electrical device according to the twelfth aspect, the tool part can be provided to a device which is coupled to the vehicle body and which extends from the vehicle body.

In accordance with a thirteenth aspect of the present invention, the electrical device according to the twelfth aspect is configured so that the item storage is provided between the first end part and the second end part in the longitudinal direction.

With the electrical device according to the thirteenth aspect, it is possible to utilize a part provided between the first end part and the second end part as a place where the item storage is provided.

In accordance with a fourteenth aspect of the present invention, the electrical device according to the twelfth or thirteenth aspect is configured so that the item storage is provided closer to one of the first end part and the second end part than to the other of the first end part and the second end part in the longitudinal direction.

With the electrical device according to the fourteenth aspect, it is possible to utilize one of a part which is close to one of the first end part 16 and the second end part for a place where the item storage is provided.

In accordance with a fifteenth aspect of the present invention, the electrical device according to any one of the twelfth to fourteenth aspects is configured so that the main body includes a grip part provided between the first end part and the second end part in the longitudinal direction.

With the electrical device according to the fifteenth aspect, it is possible to apply the item storage to a road-type operating device, for example.

In accordance with a sixteenth aspect of the present invention, the electrical device according to any one of the first to fifteenth aspects further comprises a cover configured to be detachably and reattachably attached to the main body to at least partially cover the main body.

With the electrical device according to the sixteenth aspect, the cover enables the main body to be protected against foreign matter.

In accordance with a seventeenth aspect of the present invention, the electrical device according to the sixteenth aspect is configured so that the cover is configured to be detachably and reattachably attached to the main body to at least partially cover the item storage.

With the electrical device according to the seventeenth aspect, the cover enables the item storage to be protected against foreign matter.

In accordance with an eighteenth aspect of the present invention, the electrical device according to any one of the first to seventeenth aspects further comprises a tool part provided to the main body. The tool part is configured to be engaged with a tool engagement part of an additional device of the human-powered vehicle. The tool part is provided adjacent to the item storage.

With the electrical device according to the eighteenth aspect, the tool part enables the user to conduct maintenance of the additional device. Thus, it is possible to conduct maintenance of the additional device without another tool configured to be engaged with the engagement part of the additional device.

In accordance with a nineteenth aspect of the present invention, the electrical device according to any one of the first to eighteenth aspects is configured so that the item storage is configured to store at least one of a spare part, a tool, an accessory for the human-powered vehicle, and personal belongings of a user other than the spare part, the tool, the accessory, and the human-powered vehicle.

With the electrical device according to the nineteenth aspect, it is possible to reliably improve convenience of the human-powered vehicle.

In accordance with a twentieth aspect of the present invention, the electrical device according to any one of the first to nineteenth aspects is configured so that the item is operational with respect to the electrical device or an additional electrical device in a state where the item is arranged outside the item storage.

With the electrical device according to the twentieth aspect, it is possible to reliably improve convenience of the human-powered vehicle.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a human-powered vehicle including an electrical device in accordance with one of embodiments.

FIG. 2 is a side elevational view of the electrical device of the human-powered vehicle illustrated in FIG. 1.

FIG. 3 is a cross-sectional view of the electrical device taken along line of FIG. 4.

FIG. 4 is a cross-sectional view of the electrical device taken along line IV-IV of FIG. 2.

FIG. 5 is an exploded perspective view of the electrical device illustrated in FIG. 2.

FIG. 6 is an exploded perspective view of an attachment body and an item of the electrical device illustrated in FIG. 2.

FIG. 7 is a perspective view of the attachment body and the item of the electrical device illustrated in FIG. 2.

FIG. 8 is an exploded perspective view of an attachment body and an item of the electrical device illustrated in FIG. 2 (modification).

FIG. 9 is a perspective view of the attachment body and the item of the electrical device illustrated in FIG. 2 (modification).

FIG. 10 is a perspective view of a tool part and a tool engagement part.

FIG. 11 is another perspective view of the tool part and the tool engagement part.

FIG. 12 is a side elevational view of a main body of the electrical device illustrated in FIG. 2.

FIG. 13 is a cross-sectional view of the electrical device taken along line XIII-XIII of FIG. 2.

FIG. 14 is a side elevational view of another electrical device of the human-powered vehicle illustrated in FIG. 1.

FIG. 15 is a side elevational view of another electrical device of the human-powered vehicle illustrated in FIG. 1.

FIG. 16 is a side elevational view of another electrical device of the human-powered vehicle illustrated in FIG. 1.

FIG. 17 is a side elevational view of another electrical device of the human-powered vehicle illustrated in FIG. 1.

FIG. 18 is a side elevational view of another electrical device of the human-powered vehicle illustrated in FIG. 1.

### DESCRIPTION OF THE EMBODIMENTS

The embodiments will now be described with reference to the accompanying drawings, wherein like reference numerals designate corresponding or identical elements throughout the various drawings.

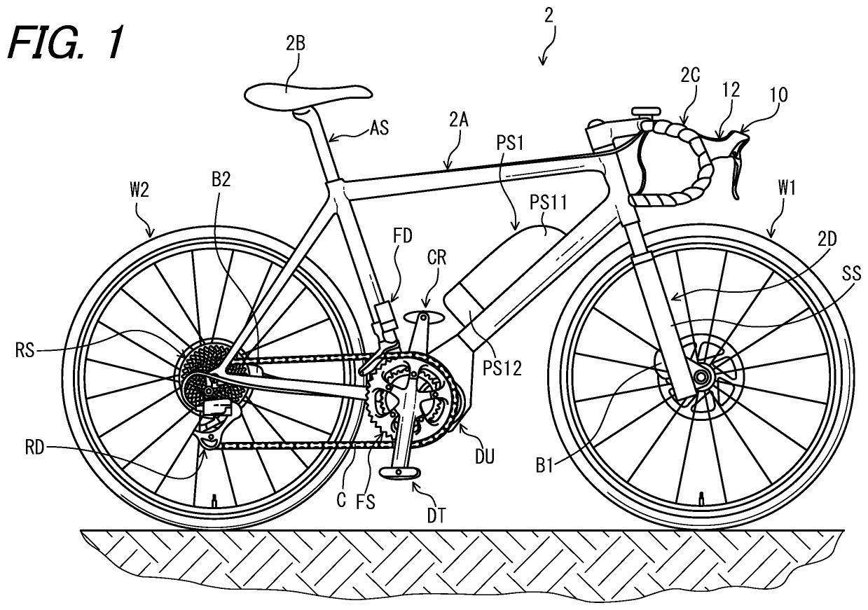

As seen in FIG. 1, a human-powered vehicle 2 includes an electrical device in accordance with an embodiment. In the present embodiment, the human-powered vehicle 2 includes electrical devices 10, 12, RD, FD, AS, SS, and DU. The electrical device 10 is configured to control another device such as the electrical devices RD, FD, AS, SS, and DU. The electrical device RD is configured to change a gear position of the human-powered vehicle 2 based on an input control instruction. The electrical device FD is configured to change a gear position of the human-powered vehicle 2 based on an input control instruction. The electrical device AS is configured to change a height of a saddle based on an input control instruction. The electrical device SS is configured to absorb and/or damp shock applied from a road surface and configured to change a state of the suspension based on an input control instruction. The electrical device DU is configured to assist impulsion of the human-powered vehicle 2. The human-powered vehicle 2 can include other electrical devices other than the electrical devices 10, 12, RD, FD, AS, SS, and DU instead of or in addition to the electrical devices 10, 12, RD, FD, AS, SS, and DU if needed and/or desired. At least one of the electrical devices 10, 12, RD, FD, AS, SS, and DU can be omitted from the human-powered vehicle 2 if needed and/or desired.

In the present application, a human-powered vehicle is a vehicle to travel with a motive power including at least a human power of a user who rides the human-powered vehicle (i.e., rider). The human-powered vehicle includes a various kind of bicycles such as a mountain bike, a road bike, a city bike, a cargo bike, a hand bike, and a recumbent bike. Furthermore, the human-powered vehicle includes an electric bike (E-bike). The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only an internal-combustion engine as motive power. Generally, a light road vehicle, which includes a vehicle that does not require a driver's license for a public road, is assumed as the human-powered vehicle.

The human-powered vehicle 2 includes a vehicle body 2A, a saddle 2B, a handlebar 2C, and a front fork 2D. The front fork 2D is rotatably mounted to the vehicle body 2A. The handlebar 2C is secured to the front fork 2D. The saddle 2B is attached to the electrical device AS. The electrical device AS is mounted to the vehicle body 2A to change a position of the saddle 2B relative to the vehicle body 2A. The electrical device SS is mounted to the front fork 2D to absorb shock transmitted from a road surface.

The human-powered vehicle 2 further includes wheels W1 and W2 and brake devices B1 and B2. The wheel W1 is rotatably coupled to the front fork 2D. The wheel W2 is rotatably coupled to the vehicle body 2A. The brake device B1 is configured to apply braking force to the wheel W1. The brake device B2 is configured to apply braking force to the wheel W2.

In the present application, the following directional terms “front,” “rear,” “forward,” “rearward,” “left,” “right,” “transverse,” “upward” and “downward” as well as any other similar directional terms refer to those directions which are determined on the basis of a user (e.g., a rider) who is in the user's standard position (e.g., on the saddle 2B or a seat) in the human-powered vehicle 2 with facing the handlebar 2C. Accordingly, these terms, as utilized to describe the electrical device 10, 12, RD, FD, AS, SS, or DU or other components, should be interpreted relative to the human-powered vehicle 2 equipped with the electrical device 10, 12, RD, FD, AS, SS, or DU as used in an upright riding position on a horizontal surface.

The human-powered vehicle 2 includes a drive train DT. The drive train DT includes a crank CR, a front sprocket assembly FS, a rear sprocket assembly RS, and a chain C. The front sprocket assembly FS is secured to the crank CR. The rear sprocket assembly RS is rotatably mounted to the vehicle body 2A. The chain C is engaged with the front sprocket assembly FS and the rear sprocket assembly RS. The electrical device RD is mounted to the vehicle body 2A and is configured to shift the chain C relative to the rear sprocket assembly RS to change a gear position. The electrical device FD is mounted to the vehicle body 2A and is configured to shift the chain C relative to the front sprocket assembly FS to change a gear position.

The human-powered vehicle 2 includes an electric power supply PS1. The electric power supply PS1 is configured to supply electricity to the electrical devices RD, FD, AS, SS, and DU. The electric power supply PS1 includes a battery PS11 and a battery holder PS12. The battery holder PS12 is coupled to the vehicle body 2V. The battery holder PS12 is configured to detachably and reattachably hold the battery PS11. Examples of the battery PS11 include a primary battery and a secondary battery. The electric power supply PS1 can be at least partially provided in the vehicle body 2V if needed and/or desired.

The term “detachably and reattachably,” as used herein, encompasses a configuration in which an element is repeatedly detachable from and attachable to another element without substantial damage.

As seen in FIG. 1, the electrical device 10 is configured to be electrically connected to the electrical device RD. The electrical device 12 is configured to be electrically connected to the electrical device RD. The electrical device RD is configured to be electrically connected to the electrical device FD. In the present embodiment, each of the electrical device 10 and the electrical device 12 is configured to be electrically connected to the electrical device RD through at least one of a wireless communication channel and a wired communication channel. The electrical device RD is configured to be electrically connected to the electrical device FD through at least one of a wireless communication channel and a wired communication channel. However, at least one of the electrical devices 10 and 12 can be configured to be electrically connected to the electrical device FD through at least one of the wireless communication channel and the wired communication channel.

The electrical device 10 is configured to receive a user input. The electrical device 10 is configured to operate at least one of the electrical devices RD, FD, AS, SS, and DU. The electrical device 12 is configured to operate at least one of the electrical devices RD, FD, AS, SS, and DU. Thus, the electrical device 10 can also be referred to as an operating device 10. The electrical device 12 can also be referred to as an operating device 12.

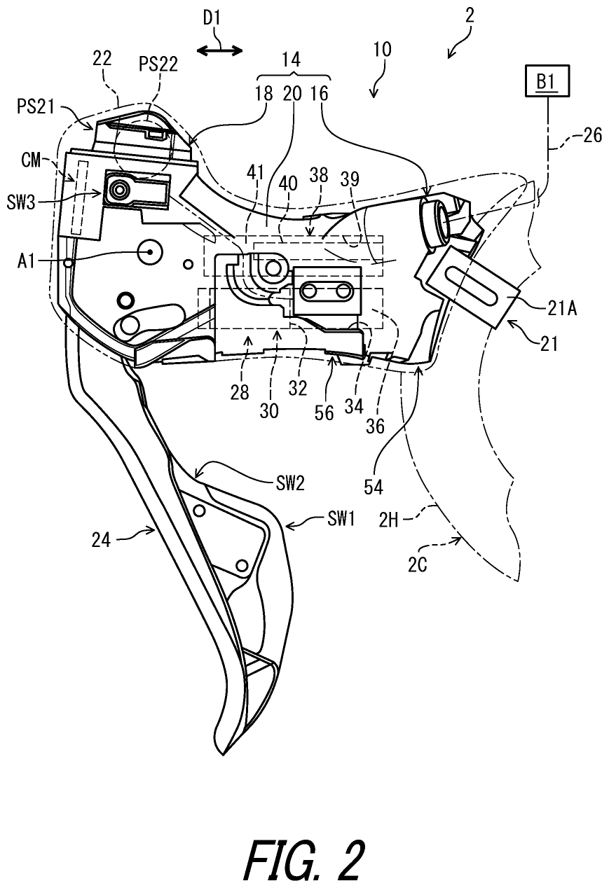

As seen in FIG. 2, the main body 14 includes a power source holder PS21. The power source holder PS21 is configured to detachably hold an electric power source PS22. Examples of the electric power source PS22 include a primary battery and a secondary battery. The power source holder PS21 is provided to the second end part 18 of the main body 14.

The electrical device 10 includes a communicator CM and switches SW1, SW2, and SW3. The communicator CM is provided to the second end part 18 of the main body 14. The switches SW1 and SW2 are mounted on a movable member 24. The switch SW3 is mounted on the main body 14. The communicator CM is electrically connected to the power source holder PS21 to receive electricity from the electric power source PS22 via the power source holder PS21.

The communicator CM is configured to communicate with another device such as the electrical devices RD, FD, AS, SS, and DU. In the present embodiment, the communicator CM is configured to wirelessly communicate with at least one of the electrical devices RD, FD, AS, SS, and DU. However, the communicator CM can be configured to communicate with at least one of the electrical devices RD, FD, AS, SS, and DU via an electric cable if needed and/or desired.

The communicator CM is electrically connected to the switches SW1, SW2, and SW3. The communicator CM is configured to transmit a control signal in response to a user input received by the switch SW1. The communicator CM is configured to transmit a control signal in response to a user input received by the switch SW2. The communicator CM is configured to transmit a control signal in response to a user input received by the switch SW3.

As seen in FIG. 2, the electrical device 10 for the human-powered vehicle 2 comprises a main body 14. Namely, the operating device 10 for the human-powered vehicle 2 comprises the main body 14. The main body 14 is configured to be coupled to a vehicle body 2A of the human-powered vehicle 2. In the present embodiment, the main body 14 is configured to be coupled to a handlebar 2H of the vehicle body 2A. However, the electrical device 10 can be coupled to other types of handlebars or other parts of the vehicle body 2A.

The main body 14 includes a first end part 16 and a second end part 18. The first end part 16 is configured to be coupled to the vehicle body 2A of the human-powered vehicle 2. The main body 14 extends between the first end part 16 and the second end part 18 in a longitudinal direction D1. The main body 14 includes a grip part 20. The grip part 20 is provided between the first end part 16 and the second end part 18 in the longitudinal direction D1.

In the present embodiment, the second end part 18 includes a pommel portion. The first end part 16 is configured to be coupled to the handlebar 2H. However, the shape of the main body 14 is not limited to the illustrated embodiment. The grip part 20 can be omitted from the main body 14 if needed and/or desired.

The electrical device 10 further comprises a mounting structure 21 configured to couple the first end part 16 to the handlebar 4. The mounting structure 21 includes a band clamp 21A. However, the mounting structure 21 can include other structures if needed and/or desired.

The electrical device 10 further comprises a cover 22. The cover 22 is configured to be detachably and reattachably attached to the main body 14 to at least partially cover the main body 14. The cover 22 is made of an elastic material such as rubber. In the present embodiment, the cover 22 is configured to partially cover the main body 14. However, the cover 22 can be configured to entirely cover the main body 14 if needed and/or desired.

The electrical device 10 further comprises a movable member 24. Namely, the operating device 10 for the human-powered vehicle 2 comprises the movable member 24. The movable member 24 is movably coupled to the main body 14. In the present embodiment, the movable member 24 is pivotally coupled to the main body 14 about a pivot axis A1. However, the movable member 24 can be coupled to the main body 14 in a manner other than a pivotable manner.

The movable member 24 is movable relative to the main body 14 to operate an operated device. Examples of the operated device include the brake device B1. The brake device B1 can also be referred to as an operated device B1. The electrical device 10 is connected to the operated device B1 via a hydraulic hose 26.

As seen in FIG. 2, the electrical device 10 for the human-powered vehicle 2 comprises an actuator 28. The actuator 28 is coupled to the main body 14. The actuator 28 is at least partially provided in the main body 14. In the present embodiment, the actuator 28 is entirely provided in the main body 14. The actuator 28 is coupled to the movable member 24 to operate the operated device B1 in response to a movement of the movable member 24. However, the actuator 28 can be configured to operate devices other than the operated device B1 if needed and/or desired. The actuator 28 can be partially provided in the main body 14 if needed and/or desired.

In the present embodiment, the actuator 28 includes a hydraulic unit 30. The hydraulic unit 30 includes a piston 32. The main body 14 includes a cylinder hole 34. The piston 32 is movably provided in the cylinder hole 34. The piston 32 is coupled to the movable member 24 to generate a hydraulic pressure in response to the movement of the movable member 24. The main body 14 and the piston 32 define a hydraulic chamber 36. The hydraulic chamber 36 is configured to be connected to the operated device B1 via the hydraulic hose 26. However, the actuator 28 can include other structures such as a cable take-up structure configured to operate an operated device via a mechanical cable (e.g., a Bowden cable).

The hydraulic unit 30 includes a reservoir 38. The main body 14 includes a reservoir recess 39. The reservoir 38 includes a diaphragm 40 provided in the reservoir recess 39. The diaphragm 40 is made on an elastic member such as rubber. The reservoir 38 includes a reservoir chamber 41. The reservoir chamber 41 is configured to be in communication with the hydraulic chamber 36 of the hydraulic unit 30. However, the reservoir 38 can be omitted from the hydraulic unit 30 if needed and/or desired.

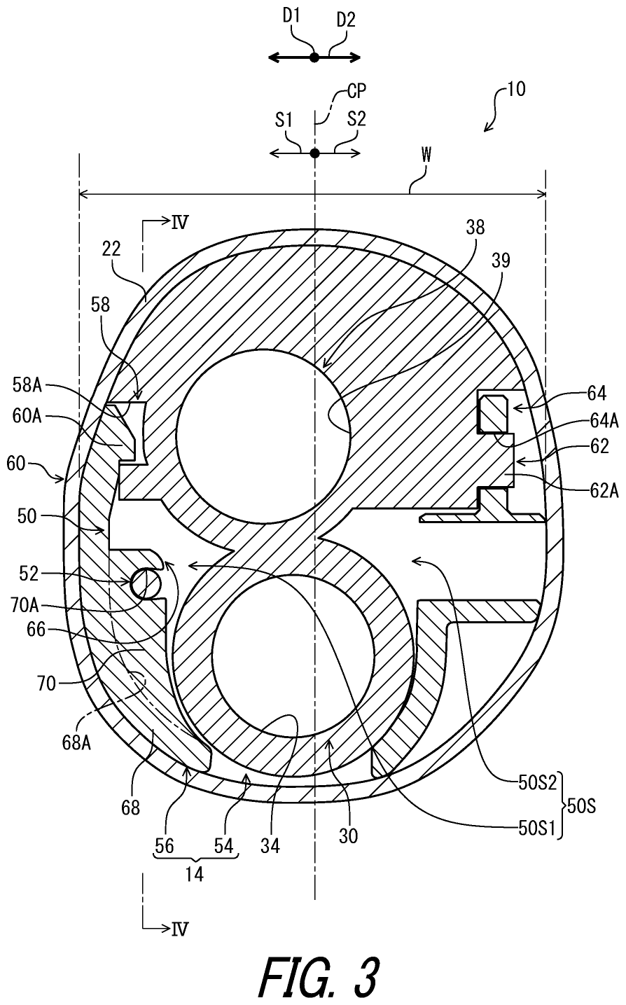

As seen in FIG. 3, the electrical device 10 for the human-powered vehicle 2 comprises an item storage 50. The item storage 50 is at least partially provided to the main body 14 so as to store an item 52. The item 52 is free from function of the electrical device 10 in a state where the item 52 is at least partially arranged in the item storage 50. The item 52 is non-operational with respect to the electrical device 10 in the state where the item 52 is at least partially arranged in the item storage 50. The item 52 is operational with respect to the electrical device 10 or an additional electrical device in a state where the item 52 is arranged outside the item storage 50. The item 52 is free from contributing to the function of the electrical device 10. Examples of the item 52 include: a spare part; the tool; an accessory for the human powered-vehicle 2; and personal belongings of the user other than the spare part, the tool, the accessory, and the human-powered vehicle 2. The item storage 50 is configured to store at least one of the spare part, the tool, the accessory for the human-powered vehicle 2, and the personal belongings of the user other than the spare part, the tool, the accessory, and the human-powered vehicle 2. Examples of the additional electrical device include the electrical devices 12, RD, FD, AS, SS, and DU in a case where the electrical device 10 includes the item storage 50. The electrical device 10 can be the additional electrical device in a case where one of the electrical devices 12, RD, FD, AS, SS, and DU includes the item storage 50. The item 52 is operational with respect to the electrical device 10 in the state where the item 52 is arranged outside the item storage 50 in a case where the item 52 is a spare part or a tool for the electrical device 10. The item 52 is operational with respect to the additional electrical device 12, RD, FD, AS, SS, or DU in the state where the item 52 is arranged outside the item storage 50 in a case where the item 52 is a spare part or a tool for the additional electrical device 12, RD, FD, AS, SS, or DU.

Examples of the spare part include a connecting link of a chain, a valve core of a wheel, a battery (e.g., a coin battery), and a fluid bottle. For example, the fluid bottle is used for supply fluid in a hydraulic unit. Examples of the tool include a hexagonal wrench and a screwdriver. Examples of the accessory include a zipper pull, a bar tape, and an electrical switch. For example, the zipper pull is used in a case where the cover 22 includes a zipper. The bar tape is used for covering the handlebar 2H of the vehicle body 2A. The electrical switch is used in the operating device 10 or 12 and/or as a satellite switch. Examples of the personal belongings include a penlight, a house key, a portable body warmer, a smoke maker, a beacon, a match, a lighter, and a whistle.

The item storage 50 includes a storage space 50S in which the item 52 is to be at least partially provided. The storage space 50S is at least partially provided inside the main body 14. In the present embodiment, the item 52 is entirely provided in the storage space 50S. The storage space 50S is entirely provided inside the main body 14. However, the item 52 can be partially provided in the storage space 50S if needed and/or desired. The storage space 50S can be at least partially outside the main body 14 (e.g., on an outer surface of the main body 14) if needed and/or desired.

The storage space 50S includes a first storage space 5051 and a second storage space 50S2. The item 52 is provided in the first storage space 5051. The first storage space 50S1 is provided on a first side 51 with respect to a transverse center plane CP in an axial direction D2 parallel to the pivot axis A1. The second storage space 5052 is provided on a second side S2 with respect to the transverse center plane CP in the axial direction D2. The main body 14 has a transverse width W defined in the axial direction D2. The transverse center plane CP is defined to bisect the transverse width W in the axial direction D2. The transverse center plane CP is defined to be perpendicular to the axial direction D2. The item 52 can be provided in the second storage space 5052 or in both of the first storage space 5051 and the second storage space 5052 if needed and/or desired. One of the first storage space 5051 and the second storage space 5052 can be omitted from the storage space 50S if needed and/or desired.

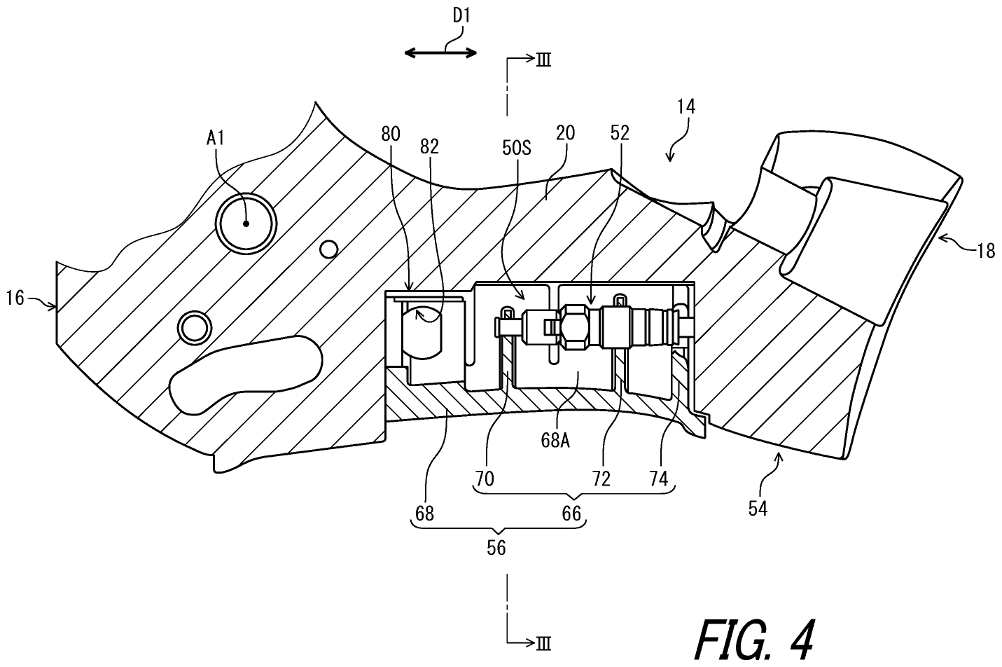

As seen in FIG. 4, the item storage 50 is provided between the first end part 16 and the second end part 18 in the longitudinal direction D1. The item storage 50 is provided closer to one of the first end part 16 and the second end part 18 than to the other of the first end part 16 and the second end part 18 in the longitudinal direction D1. The item storage 50 is at least partially provided in the grip part 20 of the main body 14. The storage space 50S is provided between the first end part 16 and the second end part 18 in the longitudinal direction D1. The storage space 50S is provided closer to one of the first end part 16 and the second end part 18 than to the other of the first end part 16 and the second end part 18 in the longitudinal direction D1.

In the present embodiment, the item storage 50 is provided closer to the second end part 18 than to the first end part 16 in the longitudinal direction D1. The storage space 50S is provided closer to the second end part 18 than to the first end part 16 in the longitudinal direction D1. However, the item storage 50 and the storage space 50S can be provided in positions other than the illustrated position if needed and/or desired. The item storage 50 can be provided closer to the first end part 16 than to the second end part 18 in the longitudinal direction D1 if needed and/or desired. The storage space 50S can be provided closer to the first end part 16 than to the second end part 18 in the longitudinal direction D1 if needed and/or desired. The item storage 50 can be provided to any part (e.g., the first end part 16, the second end part 18, a lateral surface, an upper surface, and a lower surface) of the main body 14 if needed and/or desired. The storage space 50S can be provided to any part (e.g., the first end part 16, the second end part 18, the lateral surface, the upper surface, and the lower surface) of the main body 14 if needed and/or desired.

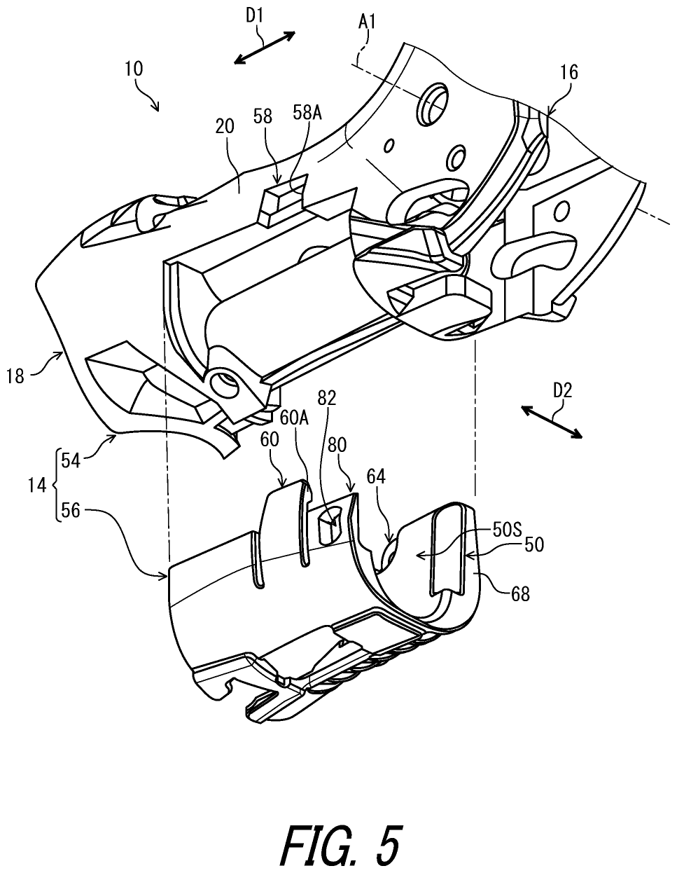

As seen in FIG. 5, the main body 14 includes a base part 54 and an attachment body 56. The attachment body 56 is configured to be detachably and reattachably attached to the base part 54. The base part 54 includes the first end part 16, the second end part 18, and the grip part 20. The attachment body 56 is a separate member from the base part 54. However, the main body 14 can be integrally provided as a one-piece unitary member if needed and/or desired.

As seen in FIG. 3, the base part 54 and the attachment body 56 define the item storage 50. The base part 54 and the attachment body 56 define the storage space 50S in which the item 52 is to be at least partially provided. The storage space 50S can also be referred to as an internal space 50S. Thus, the base part 54 and the attachment body 56 define the internal space 50S. The item storage 50 is at least partially provided to the attachment body 56. In the present embodiment, the item storage 50 is partially provided to the attachment body 56. However, the item storage 50 can be entirely provided to the attachment body 56 if needed and/or desired.

In the present embodiment, the base part 54 is made of a first material. The attachment body 56 is made of a second material. The second material is different from the first material. For example, the first material includes a metallic material such as aluminum. The second material includes a non-metallic material such as a resin material. However, the second material can be the same as the first material if needed and/or desired. The first material can include materials other than the metallic material if needed and/or desired. The second material can include materials other than the non-metallic material if needed and/or desired.

As seen in FIG. 3, the base part 54 includes a first engagement part 58. The attachment body 56 includes a second engagement part 60. The second engagement part 60 is configured to be detachably and reattachably engaged with the first engagement part 58. For example, the first engagement part 58 includes one of a protrusion and a recess which constitute a snap-fit. The second engagement part 60 includes the other of the protrusion and the recess.

In the present embodiment, the first engagement part 58 includes a recess 58A. The second engagement part 60 includes a protrusion 60A. The protrusion 60A is configured to be at least partially in the recess 58A in a state where the attachment body 56 is attached to the base part 54. The protrusion 60A and the recess 58A constitute a snap-fit. However, the structures of the first engagement part 58 and the second engagement part 60 are not limited to the illustrated embodiment.

The base part 54 includes a third engagement part 62. The attachment body 56 includes a fourth engagement part 64. The fourth engagement part 64 is configured to be detachably and reattachably engaged with the third engagement part 62. For example, the third engagement part 62 includes one of a projection and a hole. The fourth engagement part 64 includes the other of the projection and the hole.

In the present embodiment, the third engagement part 62 includes a projection 62A. The fourth engagement part 64 includes a hole 64A. The projection 62A is configured to be at least partially in the hole 64A in a state where the attachment body 56 is attached to the base part 54. However, the structures of the third engagement part 62 and the fourth engagement part 64 are not limited to the illustrated embodiment. For example, the third engagement part 62 and the fourth engagement part 64 can have the same structures as the structures of the first engagement part 58 and the second engagement part 60 if needed and/or desired. The third engagement part 62 and the fourth engagement part 64 can be omitted from the main body 14 if needed and/or desired.

The item storage 50 includes an item holder 66 configured to hold the item 52. The item holder 66 is at least partially provided in the storage space 50S. The item holder 66 is provided to the attachment body 56. The attachment body 56 includes an attachment part 68 and the item holder 66. The attachment part 68 includes an inner surface 68A at least partially define the storage space 50S. The item holder 66 is provided on the inner surface 68A of the attachment part 68. The first engagement part 58 extends from the attachment part 68. However, the item holder 66 can be provided on an outer surface of the main body 14 if needed and/or desired.

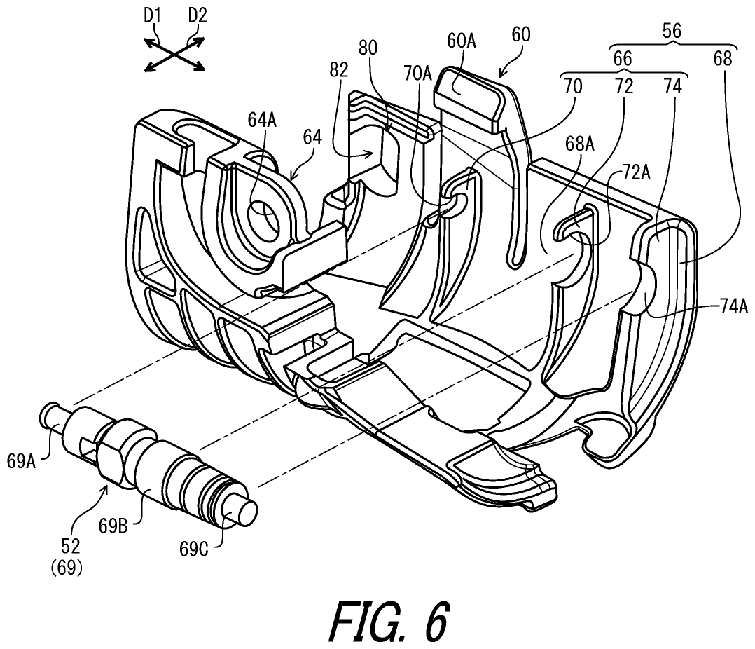

As seen in FIG. 6, for example, the item 52 includes a valve core 69 of the wheel W1 or W2 (see e.g., FIG. 1). The valve core 69 is a spare part of the wheel W1 or W2. The valve core 69 can also be referred to as an item 69. The item holder 66 includes a first holder 70, a second holder 72, and a third holder 74 in a case where the item 52 includes the valve core 69. The first holder 70 protrudes from the inner surface 68A of the attachment part 68. The second holder 72 protrudes from the inner surface 68A of the attachment part 68. The third holder 74 protrudes from the inner surface 68A of the attachment part 68.

The first holder 70, the second holder 72, and the third holder 74 are spaced apart from each other in the longitudinal direction D1. The second holder 72 is provided between the first holder 70 and the third holder 74 in the longitudinal direction D1. The first holder 70 includes a first holder opening 70A. The second holder 72 includes a second holder opening 72A. The third holder 74 includes a third holder opening 74A. The item 69 is detachably provided in the first holder opening 70A, the second holder opening 72A, and the third holder opening 74A.

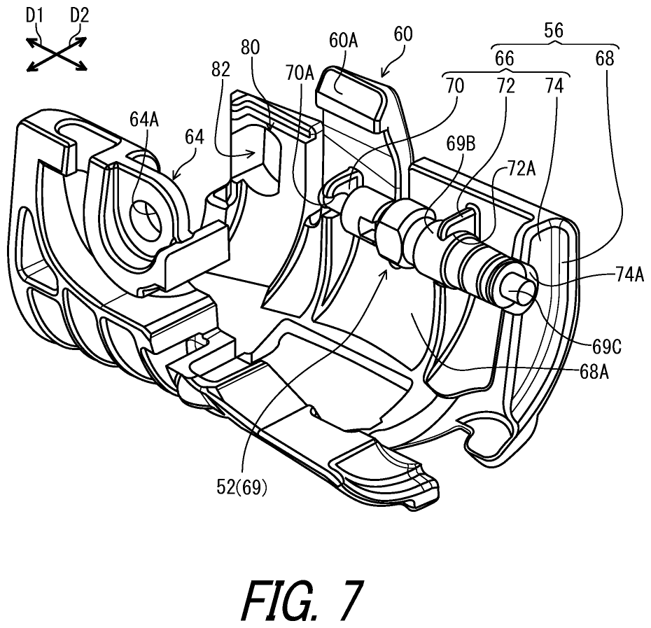

As seen in FIG. 7, in the present embodiment, the item 69 includes a first part 69A, a second part 69B, and a third part 69C. The first part 69A is detachably fitted in the first holder opening 70A in a state where the item 69 is held by the item holder 66. The second part 69B is detachably fitted in the second holder opening 72A in the state where the item 69 is held by the item holder 66. The third part 69C is provided in the third holder opening 74A in the state where the item 69 is held by the item holder 66. However, the structure of the item holder 66 is not limited to the illustrated embodiment.

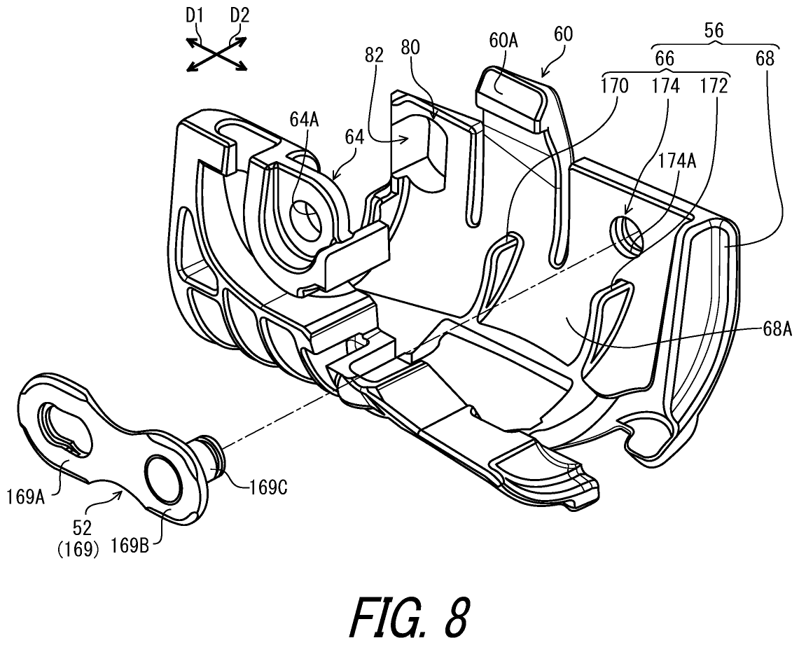

As seen in FIG. 8, for example, the item 52 includes a connecting link 169 of the chain C (see e.g., FIG. 1). The connecting link 169 is a spare part of the chain C. The connecting link 169 can also be referred to as an item 169. The item holder 66 includes a first holder 170, a second holder 172, and a third holder 174 in a case where the item 52 includes the connecting link 169. The first holder 170 protrudes from the inner surface 68A of the attachment part 68. The second holder 172 protrudes from the inner surface 68A of the attachment part 68. The third holder 174 protrudes from the inner surface 68A of the attachment part 68. The second holder 172 is spaced apart from the first holder 170 in the longitudinal direction D1. The third holder 174 is spaced apart from the first holder 170 and the second holder 172. The third holder 174 includes a holder opening 174A. The item 169 is detachably provided in the holder opening 174A.

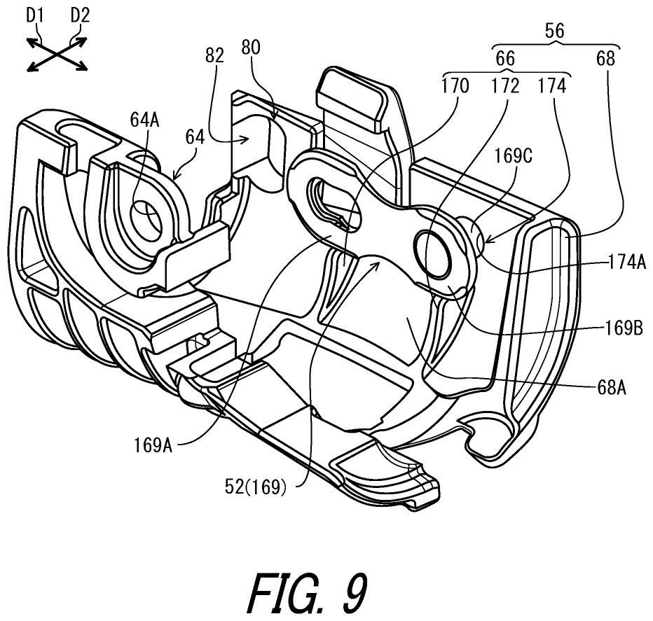

As seen in FIG. 9, in the present embodiment, the item 169 includes a first part 169A, a second part 169B, and a third part 169C. The first part 169A is put on the first holder 170 in a state where the item 169 is held by the item holder 66. The second part 169B is put on the second holder 172 in the state where the item 169 is held by the item holder 66. The third part 169C is detachably fitted in the holder opening 174A in the state where the item 169 is held by the item holder 66. However, the structure of the item holder 66 is not limited to the illustrated embodiment.

As seen in FIG. 5, the electrical device 10 for the human-powered vehicle 2 comprises a tool part 80. Namely, the operating device 10 for the human-powered vehicle 2 comprises the tool part 80. The tool part 80 is provided to the main body 14. In the present embodiment, the tool part 80 is provided to the attachment body 56. However, the tool part 80 can be provided to other parts of the electrical device 10 if needed and/or desired.

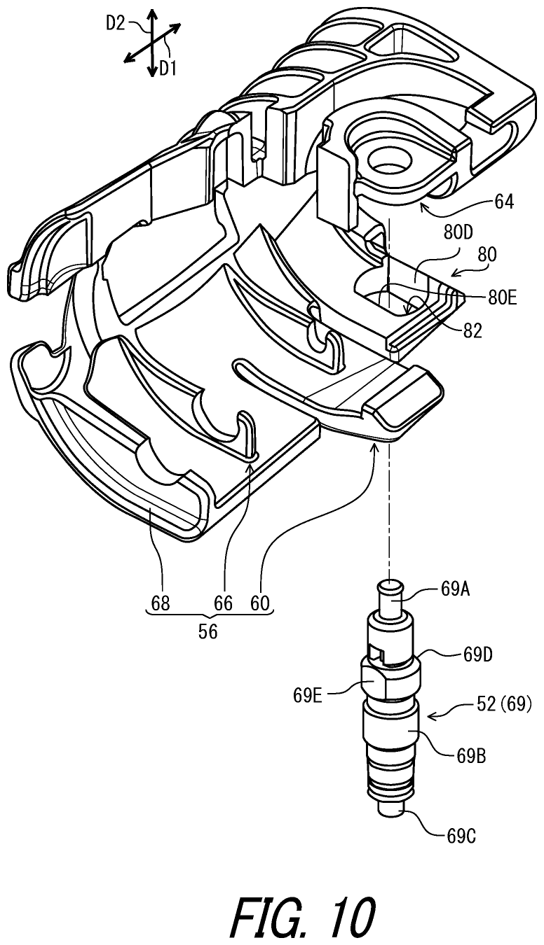

As seen in FIG. 10, the tool part 80 is configured to be engaged with a tool engagement part of an additional device of the human-powered vehicle 2. The tool part 80 includes a tool hole 82 configured to be engaged with the tool engagement part. Examples of the additional device include the wheels W1 and W2. Examples of the tool engagement part includes the valve core 69 of the wheel W1 or W2. In the present embodiment, the tool part 80 is configured to be engaged with the valve core 69 of the wheel W1 or W2. The tool hole 82 is configured to be engaged with the valve core 69 of the wheel W1 or W2. The valve core 69 can also be referred to as a tool engagement part 69. The wheel W1 or W2 can also be referred to as an additional device W1 or W2. However, the tool part 80 can be configured to be engaged with tool engagement parts other than the valve core 69 of the wheel W1 or W2 if needed and/or desired.

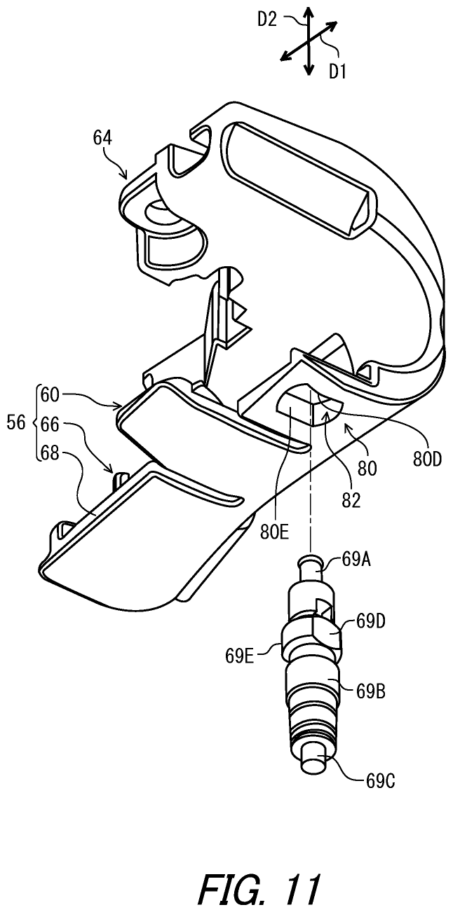

As seen in FIGS. 10 and 11, the tool part 80 includes a first tool surface 80D and a second tool surface 80E. The second tool surface 80E is spaced apart from the first tool surface 80D. The first tool surface 80D and the second tool surface 80E at least partially define the tool hole 82. The first tool surface 80D includes a flat surface. The second tool surface 80E includes a flat surface.

The tool engagement part 69 includes a first contact surface 69D and a second contact surface 69E. The second contact surface 69E is provided on a reverse side of the first contact surface 69D. The first contact surface 69D includes a flat surface. The second contact surface 69E includes a flat surface.

The first tool surface 80D is contactable with the first contact surface 69D of the tool engagement part 69. The second tool surface 80E is contactable with the second contact surface 69E of the tool engagement part 69. The first tool surface 80D, the second tool surface 80E, the first contact surface 69D, and the second contact surface 69E are configured to restrict a relative rotation between the tool part 80 and the tool engagement part 69 in a state where the tool engagement part 69 is engaged with the tool hole 82 of the tool part 80. Thus, the tool engagement part 69 can be rotated using the tool part 80 in a state where the tool part 80 is engaged with the tool engagement part 69. The tool part 80 (e.g., the attachment body 56) can be used as a tool.

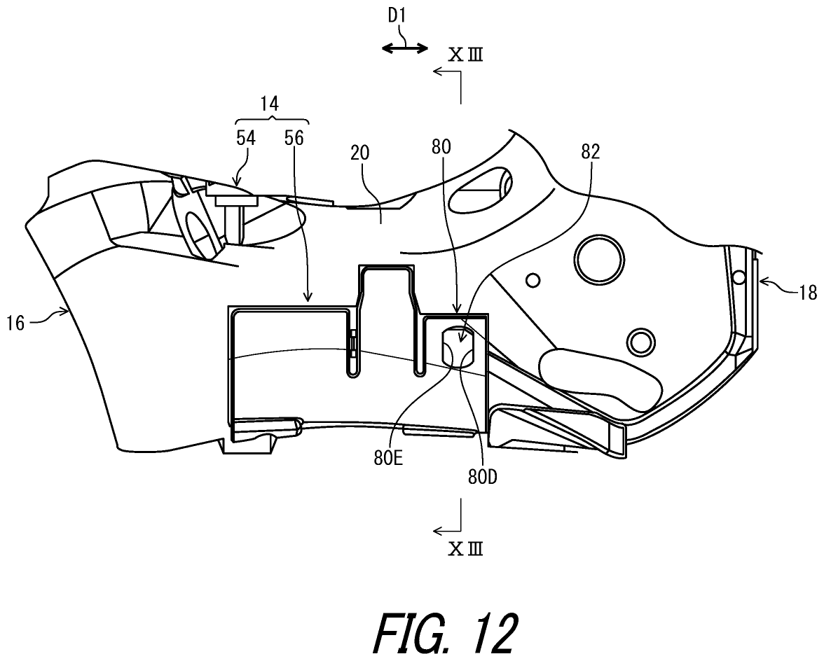

As seen in FIG. 12, the tool part 80 is provided between the first end part 16 and the second end part 18 in the longitudinal direction D1. The tool part 80 is provided closer to one of the first end part 16 and the second end part 18 than to the other of the first end part 16 and the second end part 18 in the longitudinal direction D1. The tool part 80 is provided adjacent to the item storage 50. In the present embodiment, the tool part 80 is provided closer to the first end part 16 than to the second end part 18 in the longitudinal direction D1. However, the tool part 80 can be provided in other positions if needed and/or desired. The tool part 80 can be provided closer to the second end part 18 than to the first end part 16 in the longitudinal direction D1 if needed and/or desired.

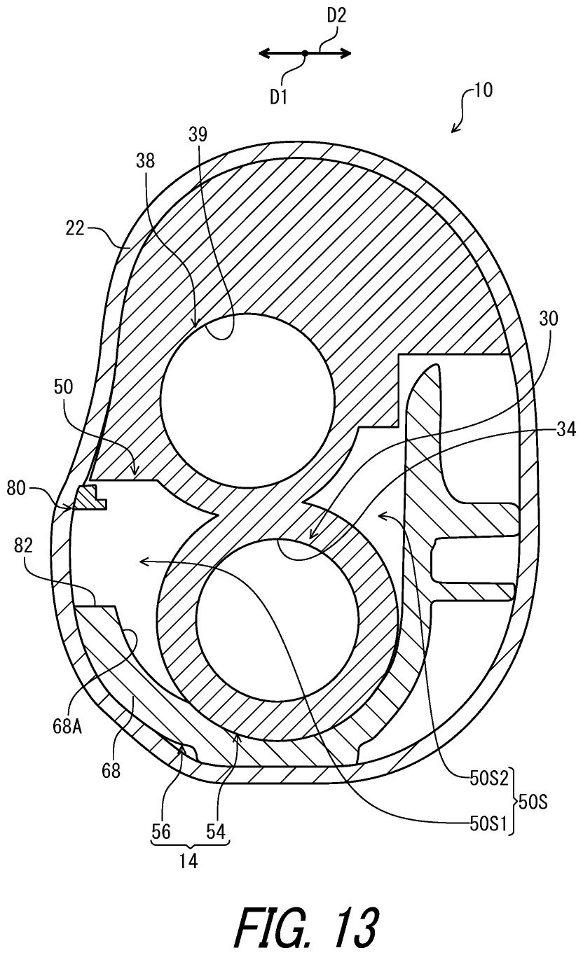

As seen in FIG. 13, the cover 22 is configured to be detachably and reattachably attached to the main body 14 to at least partially cover the tool part 80. The cover 22 is configured to be detachably and reattachably attached to the main body 14 to entirely cover the tool part 80. However, the cover 22 can be configured to be detachably and reattachably attached to the main body 14 to entirely cover the tool part 80 if needed and/or desired. The tool part 80 can be provided in a position in which the tool part 80 is not covered by the cover 22 if needed and/or desired.

The electrical device 12 has substantially the same structure as the structure of the electrical device 10. Thus, it will not be described in detail here for the sake of brevity.

In the embodiment depicted in FIGS. 1 to 13, the actuator 28 is coupled to the movable member 24 to operate the operated device B1 in response to the movement of the movable member 24. In the electrical devices RD, FD, AS, SS, and DU, however, the actuator can be coupled to the movable member to move the movable member relative to the main body. Elements having substantially the same function as those in the electrical device 10 will be numbered the same here and will not be described and/or illustrated again in detail here for the sake of brevity.

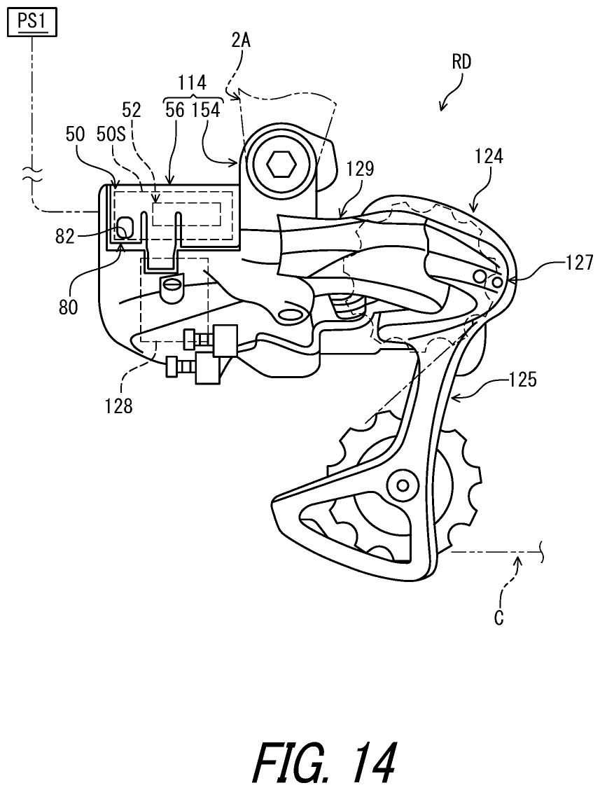

As seen in FIG. 14, the electrical device RD for the human-powered vehicle 2 comprises a main body 114. The main body 114 is configured to be coupled to the vehicle body 2A of the human-powered vehicle 2.

The electrical device RD further comprises a movable member 124. The movable member 124 is movably coupled to the main body 114. The movable member 124 includes a chain guide 125 and a coupling part 127. The chain guide 125 is contactable with the chain C. The chain guide 125 is pivotally coupled to the coupling part 127. The electrical device RD includes a linkage 129. The linkage 129 movably couples the main body 114 and the movable member 124. The linkage 129 movably couples the main body 114 and the coupling part 127.

The electrical device RD for the human-powered vehicle 2 comprises an actuator 128. The actuator 128 is coupled to the main body 114. The actuator 128 is at least partially provided in the main body 114. In the present embodiment, the actuator 128 is entirely provided in the main body 114. The actuator 128 is coupled to the movable member 124 to move the movable member 124 relative to the main body 114. The actuator 128 is coupled to movable member 124 via the linkage 129 to move the movable member 124 relative to the main body 114. Examples of the actuator 128 include an electric motor.

The electrical device RD for the human-powered vehicle 2 comprises the item storage 50. The item storage 50 includes the storage space 50S in which the item 52 is to be at least partially provided. The storage space 50S is at least partially provided inside the main body 114. In the present embodiment, the storage space 50S is entirely provided inside the main body 114. However, the item 52 can be partially provided in the storage space 50S if needed and/or desired. The storage space 50S can be at least partially outside the main body 114 (e.g., on an outer surface of the main body 114) if needed and/or desired.

The main body 114 includes a base part 154 and the attachment body 56. The attachment body 56 is configured to be detachably and reattachably attached to the base part 154. The attachment body 56 is a separate member from the base part 154. However, the main body 114 can be integrally provided as a one-piece unitary member if needed and/or desired.

The base part 154 and the attachment body 56 define the item storage 50. The base part 154 and the attachment body 56 define the storage space 50S in which the item 52 is to be at least partially provided. The storage space 50S can also be referred to as an internal space 50S. Thus, the base part 154 and the attachment body 56 define the internal space 50S. The item storage 50 is at least partially provided to the attachment body 56. In the present embodiment, the item storage 50 is partially provided to the attachment body 56. However, the item storage 50 can be entirely provided to the attachment body 56 if needed and/or desired.

The electrical device RD for the human-powered vehicle 2 comprises the tool part 80. The tool part 80 is provided to the main body 214. In the present embodiment, the tool part 80 is provided to the attachment body 56. However, the tool part 80 can be provided to other parts of the electrical device RD if needed and/or desired.

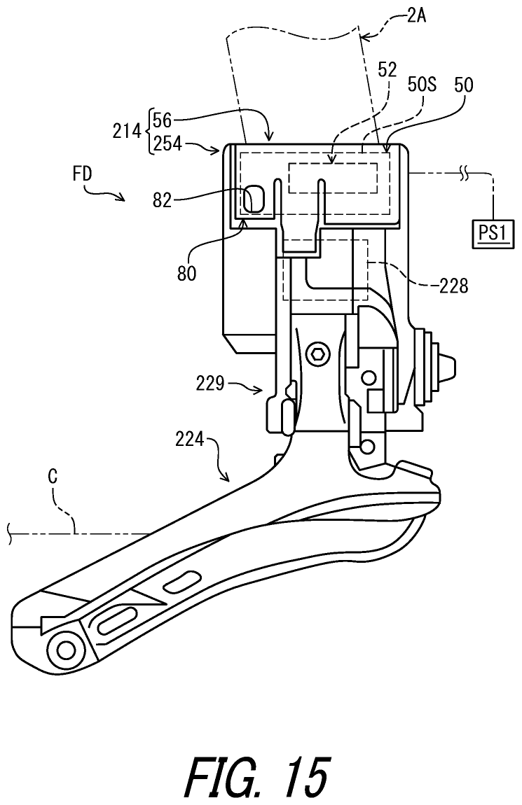

As seen in FIG. 15, the electrical device FD for the human-powered vehicle 2 comprises a main body 214. The main body 214 is configured to be coupled to the vehicle body 2A of the human-powered vehicle 2.

The electrical device FD further comprises a movable member 224. The movable member 224 is movably coupled to the main body 214. The movable member 224 is contactable with the chain C. The electrical device FD includes a linkage 229. The linkage 229 movably couples the main body 214 and the movable member 224.

The electrical device FD for the human-powered vehicle 2 comprises an actuator 228. The actuator 228 is coupled to the main body 214. The actuator 228 is at least partially provided in the main body 214. In the present embodiment, the actuator 228 is entirely provided in the main body 214. The actuator 228 is coupled to the movable member 224 to move the movable member 224 relative to the main body 214. The actuator 228 is coupled to movable member 224 via the linkage 229 to move the movable member 224 relative to the main body 214. Examples of the actuator 228 include an electric motor.

The electrical device RD for the human-powered vehicle 2 comprises the item storage 50. The item storage 50 includes the storage space 50S in which the item 52 is to be at least partially provided. The storage space 50S is at least partially provided inside the main body 214. In the present embodiment, the storage space 50S is entirely provided inside the main body 214. However, the item 52 can be partially provided in the storage space 50S if needed and/or desired. The storage space 50S can be at least partially outside the main body 214 (e.g., on an outer surface of the main body 214) if needed and/or desired.

The main body 214 includes a base part 254 and the attachment body 56. The attachment body 56 is configured to be detachably and reattachably attached to the base part 254. The attachment body 56 is a separate member from the base part 254. However, the main body 214 can be integrally provided as a one-piece unitary member if needed and/or desired.

The base part 254 and the attachment body 56 define the item storage 50. The base part 254 and the attachment body 56 define the storage space 50S in which the item 52 is to be at least partially provided. The storage space 50S can also be referred to as an internal space 50S. Thus, the base part 254 and the attachment body 56 define the internal space 50S. The item storage 50 is at least partially provided to the attachment body 56. In the present embodiment, the item storage 50 is partially provided to the attachment body 56. However, the item storage 50 can be entirely provided to the attachment body 56 if needed and/or desired.

The electrical device FD for the human-powered vehicle 2 comprises the tool part 80. The tool part 80 is provided to the main body 314. In the present embodiment, the tool part 80 is provided to the attachment body 56. However, the tool part 80 can be provided to other parts of the electrical device FD if needed and/or desired.

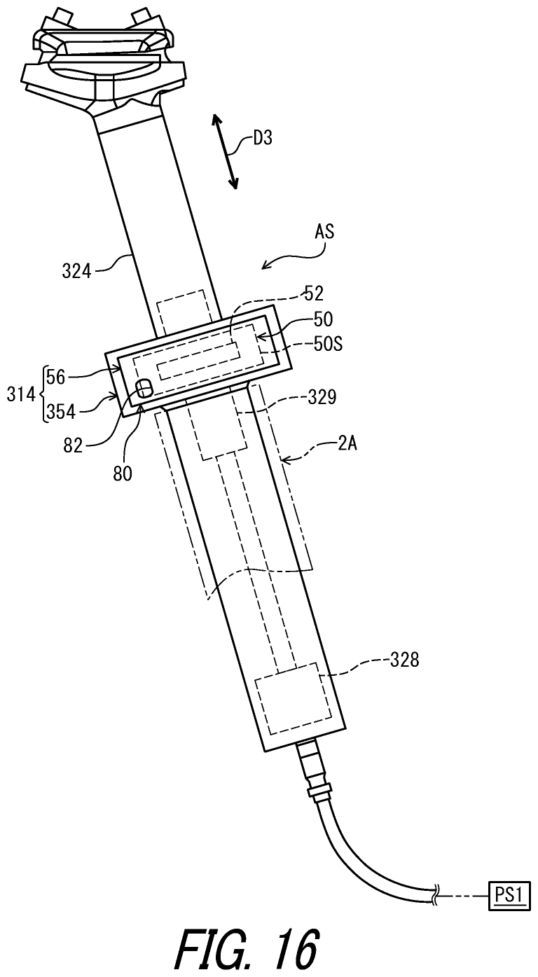

As seen in FIG. 16, the electrical device AS for the human-powered vehicle 2 comprises a main body 314. The main body 314 is configured to be coupled to the vehicle body 2A of the human-powered vehicle 2.

The electrical device AS further comprises a movable member 324. The movable member 324 is movably coupled to the main body 314. The movable member 324 is movable relative to the main body 314 in a telescopic direction D3. The saddle 2B (see e.g., FIG. 1) is secured to an end of the movable member 324.

The electrical device AS for the human-powered vehicle 2 comprises an actuator 328. The actuator 328 is coupled to the main body 314. The actuator 328 is at least partially provided in the main body 314. In the present embodiment, the actuator 328 is entirely provided in the main body 314. The actuator 328 is coupled to the movable member 324 to move the movable member 324 relative to the main body 314.

The electrical device AS includes a positioning structure 329. The positioning structure 329 is configured to change a state of the electrical device AS between a locked state and an adjustable state. In the locked state, the movable member 324 is locked relative to the main body 314 by the positioning structure 329. In the adjustable state, the movable member 324 is movable relative to the main body 314 in the telescopic direction D3. The actuator 328 is coupled to the positioning structure 329 to change the state of the electrical device AS between the locked state and the adjustable state. Examples of the actuator 328 include an electric motor. Examples of the positioning structure 329 includes a hydraulic positioning structure and a ball screw.

The electrical device AS for the human-powered vehicle 2 comprises the item storage 50. The item storage 50 includes the storage space 50S in which the item 52 is to be at least partially provided. The storage space 50S is at least partially provided inside the main body 314. In the present embodiment, the storage space 50S is entirely provided inside the main body 314. However, the item 52 can be partially provided in the storage space 50S if needed and/or desired. The storage space 50S can be at least partially outside the main body 314 (e.g., on an outer surface of the main body 314) if needed and/or desired.

The main body 314 includes a base part 354 and the attachment body 56. The attachment body 56 is configured to be detachably and reattachably attached to the base part 354. The attachment body 56 is a separate member from the base part 354. However, the main body 314 can be integrally provided as a one-piece unitary member if needed and/or desired.

The base part 354 and the attachment body 56 define the item storage 50. The base part 354 and the attachment body 56 define the storage space 50S in which the item 52 is to be at least partially provided. The storage space 50S can also be referred to as an internal space 50S. Thus, the base part 354 and the attachment body 56 define the internal space 50S. The item storage 50 is at least partially provided to the attachment body 56. In the present embodiment, the item storage 50 is partially provided to the attachment body 56. However, the item storage 50 can be entirely provided to the attachment body 56 if needed and/or desired.

The electrical device AS for the human-powered vehicle 2 comprises the tool part 80. The tool part 80 is provided to the main body 314. In the present embodiment, the tool part 80 is provided to the attachment body 56. However, the tool part 80 can be provided to other parts of the electrical device AS if needed and/or desired.

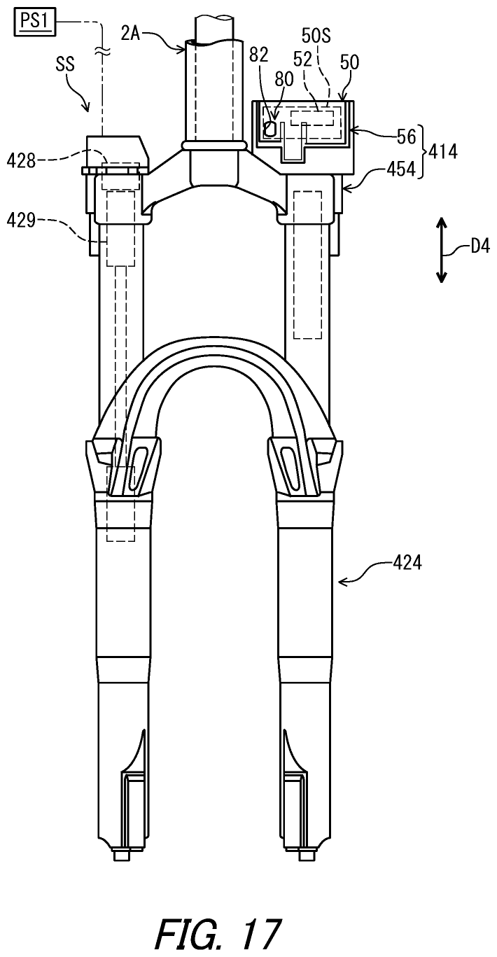

As seen in FIG. 17, the electrical device SS for the human-powered vehicle 2 comprises a main body 414. The main body 414 is configured to be coupled to the vehicle body 2A of the human-powered vehicle 2.

The electrical device SS further comprises a movable member 424. The movable member 424 is movably coupled to the main body 414. The movable member 424 is movable relative to the main body 414 in a telescopic direction D4. The wheel W1 (see e.g., FIG. 1) is rotatably coupled to an end of the movable member 424.

The electrical device SS for the human-powered vehicle 2 comprises an actuator 428. The actuator 428 is coupled to the main body 414. The actuator 428 is at least partially provided in the main body 414. In the present embodiment, the actuator 428 is entirely provided in the main body 414. The actuator 428 is coupled to the movable member 424 to move the movable member 424 relative to the main body 414.

The electrical device SS includes a state changing structure 429. The state changing structure 429 is configured to change a state of the electrical device SS. For example, the state changing structure 429 is configured to change a stroke or damper property of the electrical device SS. Examples of the actuator 428 include an electric motor.

The electrical device SS for the human-powered vehicle 2 comprises the item storage 50. The item storage 50 includes the storage space 50S in which the item 52 is to be at least partially provided. The storage space 50S is at least partially provided inside the main body 414. In the present embodiment, the storage space 50S is entirely provided inside the main body 414. However, the item 52 can be partially provided in the storage space 50S if needed and/or desired. The storage space 50S can be at least partially outside the main body 414 (e.g., on an outer surface of the main body 414) if needed and/or desired.

The main body 414 includes a base part 454 and the attachment body 56. The attachment body 56 is configured to be detachably and reattachably attached to the base part 454. The attachment body 56 is a separate member from the base part 454. However, the main body 414 can be integrally provided as a one-piece unitary member if needed and/or desired.

The base part 454 and the attachment body 56 define the item storage 50. The base part 454 and the attachment body 56 define the storage space 50S in which the item 52 is to be at least partially provided. The storage space 50S can also be referred to as an internal space 50S. Thus, the base part 454 and the attachment body 56 define the internal space 50S. The item storage 50 is at least partially provided to the attachment body 56. In the present embodiment, the item storage 50 is partially provided to the attachment body 56. However, the item storage 50 can be entirely provided to the attachment body 56 if needed and/or desired.

The electrical device SS for the human-powered vehicle 2 comprises the tool part 80. The tool part 80 is provided to the main body 414. In the present embodiment, the tool part 80 is provided to the attachment body 56. However, the tool part 80 can be provided to other parts of the electrical device SS if needed and/or desired.

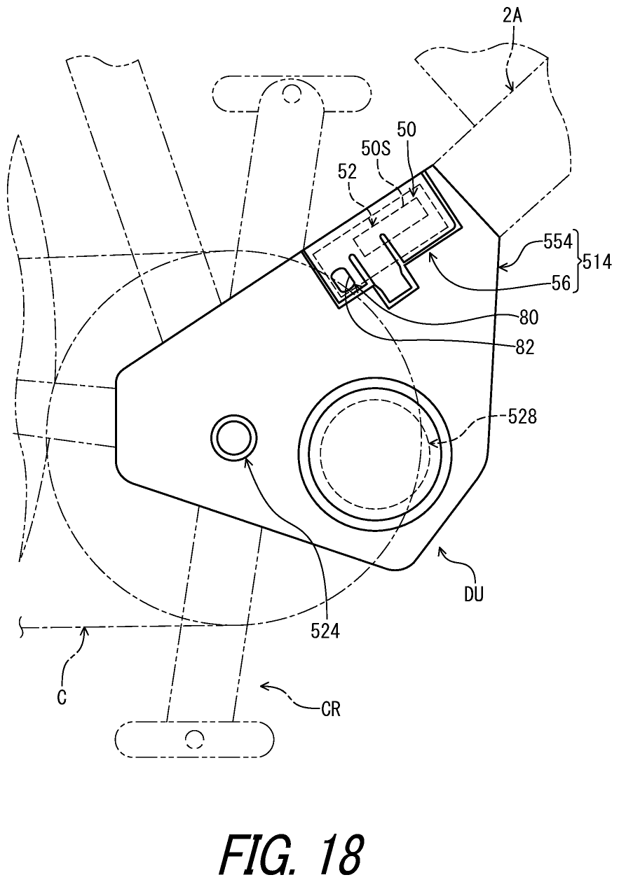

As seen in FIG. 18, the electrical device DU for the human-powered vehicle 2 comprises a main body 514. The main body 514 is configured to be coupled to the vehicle body 2A of the human-powered vehicle 2.

The electrical device DU further comprises a movable member 524. The movable member 524 is movably coupled to the main body 514. The movable member 524 is rotatably supported by the main body 514. The movable member 524 corresponds to a crank axle of the crank CR.

The electrical device DU for the human-powered vehicle 2 comprises an actuator 528. The actuator 528 is coupled to the main body 514. The actuator 528 is at least partially provided in the main body 514. In the present embodiment, the actuator 528 is entirely provided in the main body 514. The actuator 528 is coupled to the movable member 524 to move the movable member 524 relative to the main body 514. The actuator 528 is coupled to the movable member 524 to rotate the movable member 524 relative to the main body 514. For example, the actuator 528 is coupled to the movable member 524 via at least one gear. Examples of the actuator 528 include an electric motor.

The electrical device DU for the human-powered vehicle 2 comprises the item storage 50. The item storage 50 includes the storage space 50S in which the item 52 is to be at least partially provided. The storage space 50S is at least partially provided inside the main body 514. In the present embodiment, the storage space 50S is entirely provided inside the main body 514. However, the item 52 can be partially provided in the storage space 50S if needed and/or desired. The storage space 50S can be at least partially outside the main body 514 (e.g., on an outer surface of the main body 514) if needed and/or desired.

The main body 514 includes a base part 554 and the attachment body 56. The attachment body 56 is configured to be detachably and reattachably attached to the base part 554. The attachment body 56 is a separate member from the base part 554. However, the main body 514 can be integrally provided as a one-piece unitary member if needed and/or desired.

The base part 554 and the attachment body 56 define the item storage 50. The base part 554 and the attachment body 56 define the storage space 50S in which the item 52 is to be at least partially provided. The storage space 50S can also be referred to as an internal space 50S. Thus, the base part 554 and the attachment body 56 define the internal space 50S. The item storage 50 is at least partially provided to the attachment body 56. In the present embodiment, the item storage 50 is partially provided to the attachment body 56. However, the item storage 50 can be entirely provided to the attachment body 56 if needed and/or desired.

The electrical device DU for the human-powered vehicle 2 comprises the tool part 80. The tool part 80 is provided to the main body 514. In the present embodiment, the tool part 80 is provided to the attachment body 56. However, the tool part 80 can be provided to other parts of the electrical device DU if needed and/or desired.

In the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. An electrical device for a human-powered vehicle, comprising:
a main body configured to be coupled to a vehicle body of the human-powered vehicle;
an item storage at least partially provided to the main body so as to store an item, the item being free from function of the electrical device or non-operational with respect to the electrical device in a state where the item is at least partially arranged in the item storage; and
an actuator coupled to the main body.

2. The electrical device according to claim 1, wherein
the item storage includes a storage space in which the item is to be at least partially provided.

3. The electrical device according to claim 1, wherein
the item storage includes an item holder configured to hold the item.

4. The electrical device according to claim 3, wherein
the item holder is at least partially provided in the storage space.

5. The electrical device according to claim 3, wherein
the storage space is at least partially provided inside the main body.

6. The electrical device according to claim 1, wherein
the main body includes
a base part, and
an attachment body configured to be detachably and reattachably attached to the base part, and
the item storage is at least partially provided to the attachment body.

7. The electrical device according to claim 6, wherein
the base part and the attachment body define a storage space in which the item is to be at least partially provided.

8. The electrical device according to claim 6, wherein
the base part includes a first engagement part, and
the attachment body includes a second engagement part configured to be detachably and reattachably engaged with the first engagement part.

9. The electrical device according to claim 1, further comprising
a movable member movably coupled to the main body.

10. The electrical device according to claim 9, wherein
the actuator is coupled to the movable member to operate an operated device in response to a movement of the movable member.

11. The electrical device according to claim 9, wherein
the actuator is coupled to the movable member to move the movable member relative to the main body.

12. The electrical device according to claim 1, wherein
the main body includes a first end part and a second end part,
the first end part is configured to be coupled to a vehicle body of the human-powered vehicle, and
the main body extends between the first end part and the second end part in a longitudinal direction.

13. The electrical device according to claim 12, wherein
the item storage is provided between the first end part and the second end part in the longitudinal direction.

14. The electrical device according to claim 12, wherein
the item storage is provided closer to one of the first end part and the second end part than to the other of the first end part and the second end part in the longitudinal direction.

15. The electrical device according to claim 12, wherein
the main body includes a grip part provided between the first end part and the second end part in the longitudinal direction.

16. The electrical device according to claim 1, further comprising
a cover configured to be detachably and reattachably attached to the main body to at least partially cover the main body.

17. The electrical device according to claim 16, wherein
the cover is configured to be detachably and reattachably attached to the main body to at least partially cover the item storage.

18. The electrical device according to claim 1, further comprising
a tool part provided to the main body and configured to be engaged with a tool engagement part of an additional device of the human-powered vehicle,
the tool part is provided adjacent to the item storage.

19. The electrical device according to claim 1, wherein
the item storage is configured to store at least one of
a spare part,
a tool,
an accessory for the human-powered vehicle, and
personal belongings of a user other than the spare part, the tool, the accessory, and the human-powered vehicle.

20. The electrical device according to claim 1, wherein
the item is operational with respect to the electrical device or an additional electrical device in a state where the item is arranged outside the item storage.
